(19) United States
(12) Patent Application Publication
(10) Pub. No.: US 2015/0347732 A1
(43) Pub. Date: Dec. 3, 2015

(54) Electronic Device and Method for Controlling Access to Same

(71) Applicant: Google Technology Holdings LLC, Mountain View, CA (US)

(72) Inventors: Rachid M. Alameh, Crystal Lake, IL (US); Jiri Slaby, Buffalo Grove, IL (US)

(21) Appl. No.: 14/289,978

(22) Filed: May 29, 2014

(51) Int. Cl. G06F 21/32

(52) U.S. Cl. CPC G06F 21/32

(57) ABSTRACT

An electronic device selects, based the detected position of a user, which sensor it will use to authenticate the user. The device may, for example, select a first sensor based on a first position and motion of the user, grant a first level of access to the user based on an authentication procedure the device carries out using data from the first sensor, select a second sensor based on a second position and motion of the user, and grant a second level of access to the user based on an authentication procedure the device carries out using data from the second sensor.

### TECHNICAL FIELD

The present disclosure is related generally to user authentication techniques on electronic devices.

### BACKGROUND

Although the potential advantages of using biometric authentication over traditional personal identification number (“PIN”) authentication has long been understood, its use in consumer electronic devices has only recently become popular. With biometric authentication, a user need not enter a PIN and, under the right conditions, need not even be touching the device in order to unlock it.

Most existing biometric authentication schemes use the same basic access logic that traditional PIN-based systems use. That is, a user is either authenticated or is not. The user either gains full access or no access. Furthermore, they generally do not adjust in real-time for dynamic conditions such as the movement and position of the user.

### DRAWINGS

While the appended claims set forth the features of the present techniques with particularity, these techniques, together with their objects and advantages, may be best understood from the following detailed description taken in conjunction with the accompanying drawings of which:

FIG. 1A is a front view of an electronic device according to an embodiment;

FIG. 1B is a rear view of the electronic device according to an embodiment;

FIG. 2 is a block diagram of the electronic device according to an embodiment;

FIG. 3 is a process flow diagram of a method that may be carried out in an embodiment;

FIG. 4 is a diagrammatic view of a scenario in which the electronic device may be used; and

FIG. 5 is a process flow diagram of a method that may be carried out in another embodiment.

### DESCRIPTION

According to various embodiments, an electronic device selects, based the detected motion and position of a user, which sensor it will use to authenticate the user. The device may, for example, select a first sensor based on a first position of the user, grant a first level of access to the user based on an authentication procedure the device carries out using data from the first sensor, select a second sensor based on a second position and motion (e.g., gait or speed) of the user, and grant a second level of access to the user based on an authentication procedure the device carries out using data from the second sensor. The number of possible access levels is not limited, and the example of two levels discussed herein is only meant to be illustrative.

The electronic device may also select the sensor based on the speed of the user and the context of the device, such as the device's environment, including detected audio noise, the detected lighting around the device, and the location of the device. For example, if the environment is too noisy, then the processor of the device may not be able to rely on a sound sensor (e.g., microphone) of the device to authenticate the user, but may instead need to rely on an imager of the device. Conversely, if the ambient light level is too low, then the processor may not be able to rely on the imager, but may instead need to rely on the sound sensor of the device.

In an embodiment, an electronic device detects one or both of a first position and a first motion of a user relative to the electronic device. The device identifies, based on one or both of the first detected position and the first detected motion, which type of sensor of the plurality of types of sensors is the most appropriate for use in attempting to authenticate the user. The device receives a first set of data regarding the user from a sensor of the identified first type, carries out a first authentication procedure on the user using the received first set of data, grants a first level access to the user based on the first authentication procedure, and detects one or both of a second position and a second motion of the user relative to the electronic device. The device identifies, based on one or both of the second detected position and second detected motion, which type of sensor of the plurality of types of sensors is the most appropriate for use in attempting to authenticate the user, receives a second set of data regarding the user from a sensor of the identified second type, carries out a second authentication procedure on the user using the received second set of data, and grants a second level of access to the user based on the second authentication procedure.

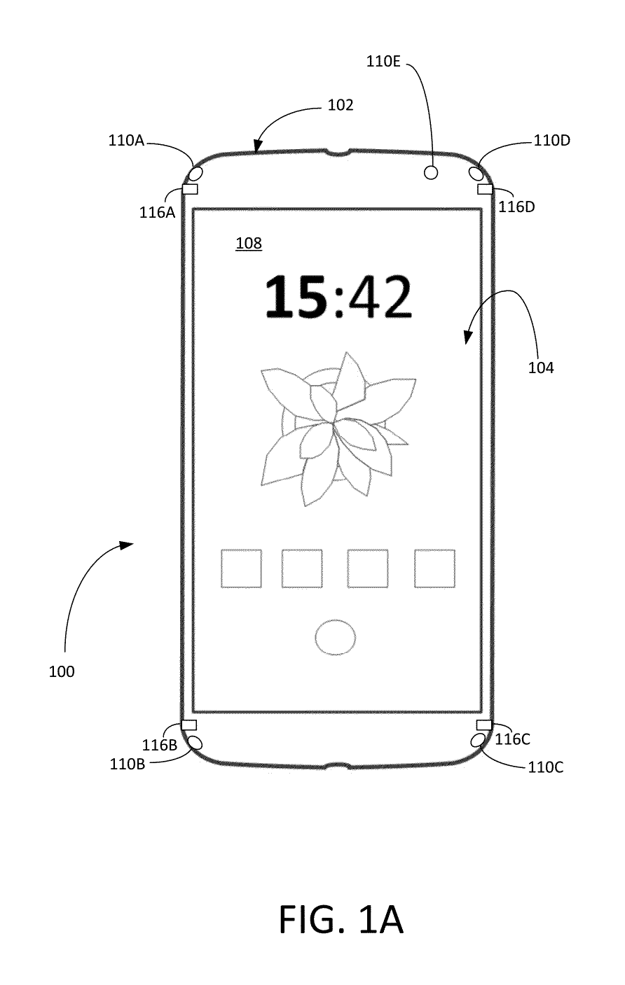

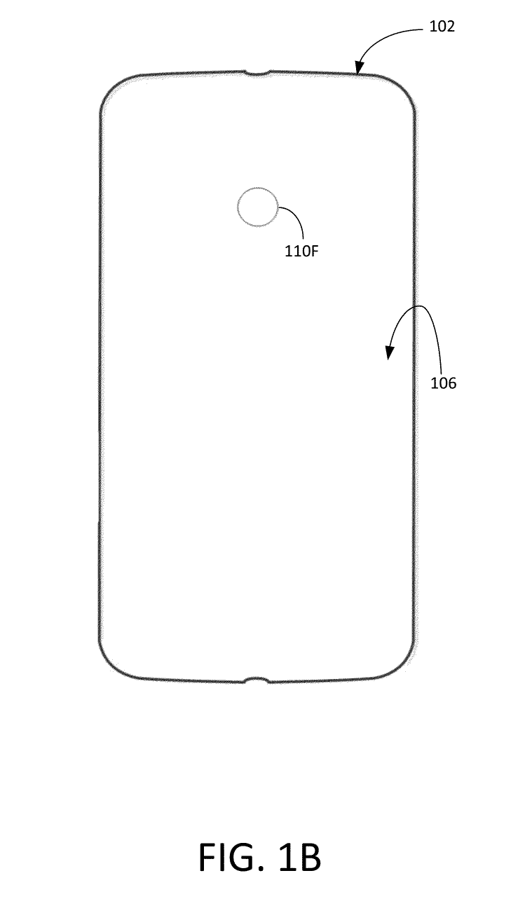

Turning to FIG. 1A and FIG. 1B, an embodiment of the electronic device (“the device”), generally labeled 100, includes a housing 102 having a front side 104 and a rear side 106. Set along the perimeter of the housing are sensors, including a number of imagers (an imager such as a camera is a type of sensor in this context). The imagers include a first imager 110A, a second imager 110B, a third imager 110C, and a fourth imager 110D. Each of the first through fourth imagers has a field of view that extends outwardly from the perimeter of the device 100. Also set along the perimeter of the device 100 are a first motion sensor 116A, a second motion sensor 116B, a third motion sensor 116C, and a fourth motion sensor 116D. Each motion sensor may be implemented as a passive infrared detector, such as a digital thermopile sensor, or as an active sensor that uses reflected light of a light source of the device 100. In some embodiments, one or more of the motion sensors are implemented as microphones.

Set within the front side 104 of the housing 102 is a display 108 (e.g., an organic light-emitting diode display) and a fifth imager 110E (e.g., a front facing camera). Set within the rear side 106 of the housing 102 is a sixth imager 110F (e.g., a rear facing camera). Although depicted in FIGS. 1A and 1B as a smartphone, the electronic device 100 may be implemented as other types of devices, including a tablet computer, portable gaming device, and a wearable device (e.g., a smart watch).

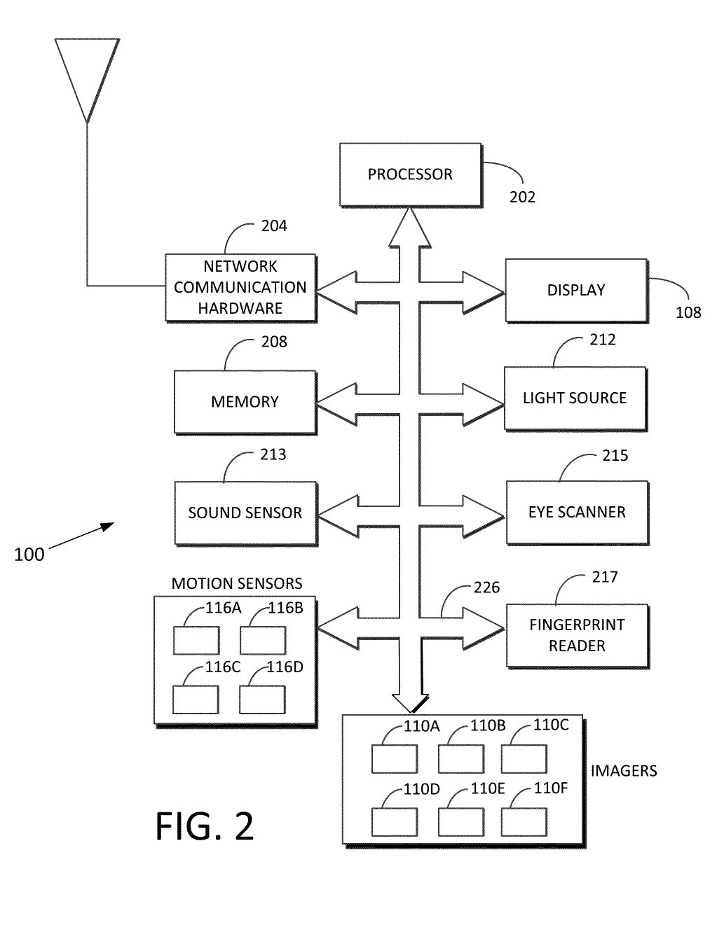

Turning to FIG. 2, an embodiment of the electronic device 100 includes a processor 202, a network communication module 204 (e.g., WiFi chip or a cellular baseband chipset), a memory 208 (which can be implemented as volatile memory or non-volatile memory), and a light source 212 (e.g., an infrared light-emitting diode). The device 100 also includes a number of additional sensors, including a sound sensor 213 (e.g., a microphone), an eye scanner 215 (e.g., retina, vein, or cornea scanner), and a fingerprint reader 217.

Each of the elements of FIG. 1 is communicatively linked to one or more other elements via one or more data pathways 226. Possible implementations of the data pathways 226 include wires, conductive pathways on a microchip, and wireless connections. Possible implementations of the processor 202 include a microprocessor and a controller. In various embodiments, the processor 202 and the sensors of the device 100 are configured to carry out methods described herein. To carry out methods, the processor 202 retrieves instructions and data from the memory 208 and, using the instructions and data, executes various parts of the methods. The sensors (including the imagers) are configured to detect various characteristics of users and collect data about users. The sensors are configured to provide such data to the processor 202, which may use the data immediately or store it in the memory 208.

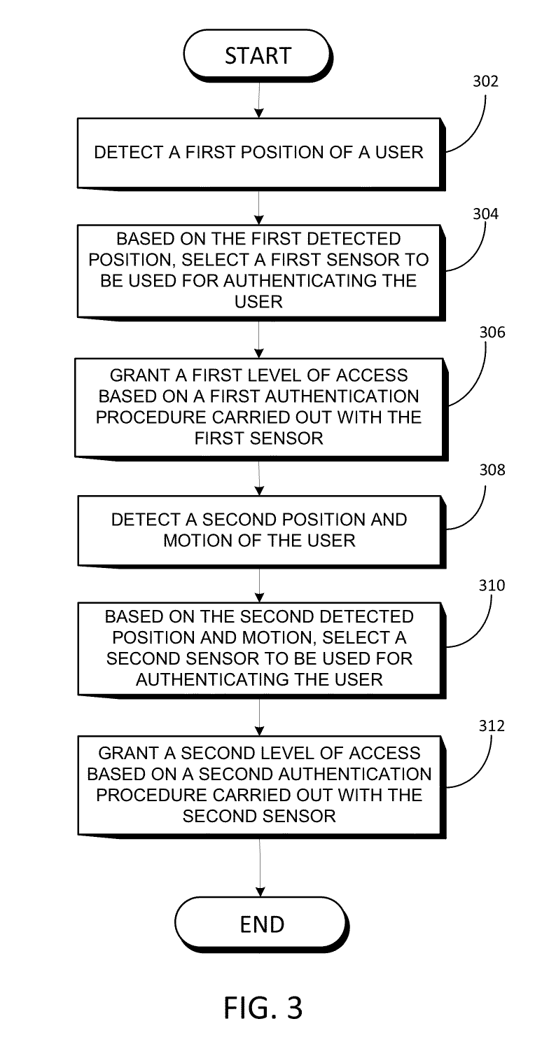

Turning to the process flow diagram of FIG. 3, a procedure carried out by the electronic device 100 in an embodiment will now be described. At block 302, the device 100 detects a first position of a user. At block 304, the processor 202 selects, based on the first position, a first sensor (e.g., the sound sensor 213) to be used to authenticate the user. At block 306, the processor 202 grants a first level of access to the user based on an authentication procedure (e.g., sound recognition) that the processor 202 carries out using the first sensor. The first level of access may involve granting the user 302 access to telephone functions or lower security applications of the device 100. For example, the processor 202 may control the audio output 206 to inform that user 302 that “You missed two phone calls and have one voicemail.” The processor 202 may also control the display 108 to display the user's access level (e.g., “You are now able to access the phone functions”).

At block 308, the device 100 detects a second position and motion of the user. At block 310, the processor 202 selects, based on the second position and motion, a second sensor (e.g., one of the imagers) to be used to authenticate the user. At block 312, the processor 202 grants a second level of access to the user based on the second authentication procedure (e.g., facial recognition) carried out with the second sensor. Granting the second level of access may involve the processor 202 granting the user 402 access to one or more of pictures, files, emails, or higher security applications on the device 100. The processor 202 may also control the display 108 to display the user's access level (e.g., “You are now able to access email”).

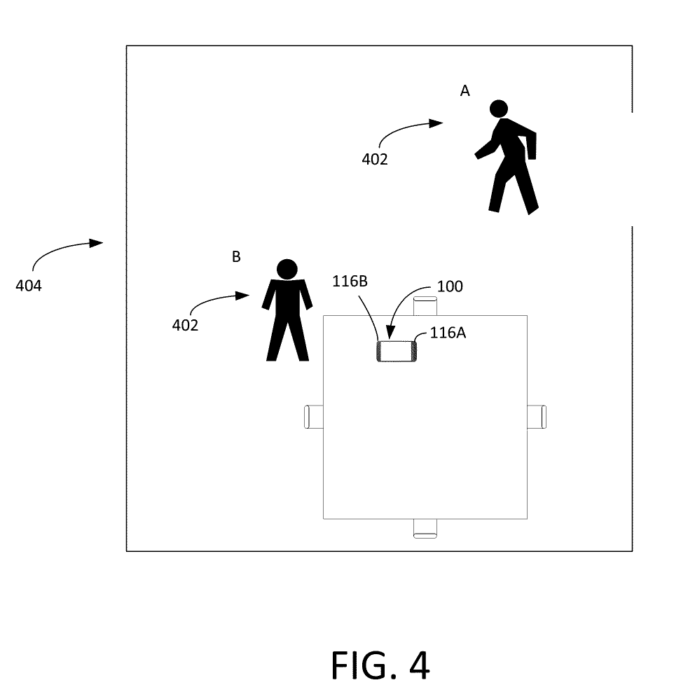

Turning to FIG. 4, examples of how the different parts of the process of FIG. 3 may be carried out will now be described. As shown in FIG. 4, the electronic device 100 is lying on a table in a room 404. In one example, a user 402 of the device enters the room 404 at position A and is moving. The first motion sensor 116A detects the user's position when the user 402 is at position A (block 302). The first motion sensor 116A provides data regarding the user's position to the processor 202. The processor 202 determines that the user 402 (at position A) too far away (e.g., more than 10 feet) to allow for effective image recognition. Based on the distance and motion of the user 402, the processor 202 selects the sound sensor 213 to be used for authenticating the user 402 (block 304). The processor 202 then receives audio data from the sound sensor 213 and carries out a sound-based authentication procedure (e.g., voice recognition) on the user 402 based on the received audio data and grants the user 402 a first level of access based on the sound-based authentication procedure (block 306).

The second motion sensor 116B then detects (block 308) that the user 402 has moved to a second position (position B). In this example, it will be assumed that, at position B, the user 402 is close enough (e.g., within 2 feet) to the device 100 and stationary enough for effective image recognition. Based on this information, the processor 202 selects an imager (e.g., the fifth imager 110E) to be used for authenticating the user 402 (block 310). The processor 202 then controls the imager to capture an image of the user 402. The processor 202 then carries out an image recognition (e.g., facial recognition) procedure using the image, and is able to authenticate the user 402 to a confidence level sufficient for granting the second level of access (block 312).

Another way that blocks 308 through 312 may be carried out is that the device 100 detects that the user 402 has moved close enough (e.g., within 1 foot) and is stationary enough for an effective eye scan (e.g., retina scan, vein scan, or iris scan) (block 308). Based on this information, the processor 202 selects the eye scanner 215 to be used for authenticating the user 402 (block 310). The processor 202 then controls the eye scanner 215 to scan the user's eye and carry out the appropriate recognition (e.g., retina, vein, or iris recognition) procedure, and is able to authenticate the user 402 to a confidence level sufficient for granting the second level of access (block 312). In some embodiments, one of the imagers acts as the eye scanner.

In a variation on the previous example, the device 100 may instead detect that the user 402 is holding the device 100 (block 308) and is motionless, select the fingerprint reader 222 based on this information (block 310), and carry out an authentication procedure on the user's fingerprint using the fingerprint reader 217. If the processor 202 is able to authenticate the user 402 with a sufficient level of confidence, the processor 202 grants the user 402 the second level of access (block 312).

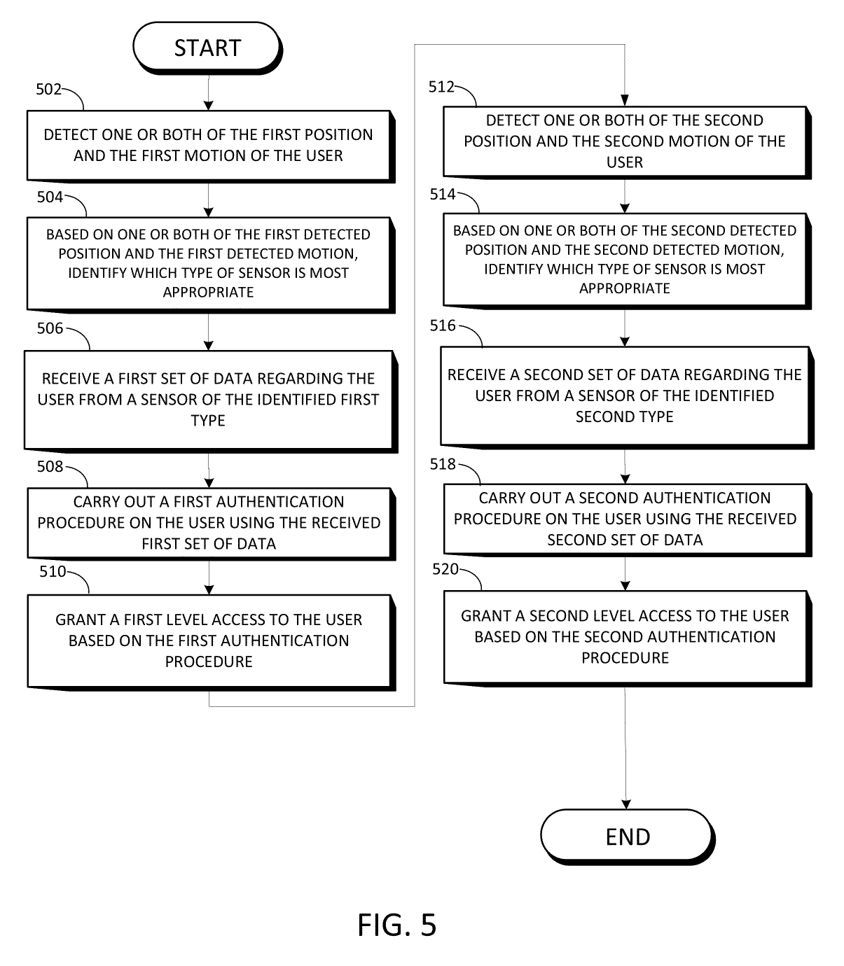

Turning to FIG. 5, another procedure that the electronic device 100 carries out in an embodiment out will now be described. At block 502, the device 100 (i.e., one or more of its sensors) detects one or both of the first position and the first motion of the user 402. At block 504, the processor 202 identifies, based on one or both of the first detected position and the first detected motion, which type of sensor is most appropriate to use to authenticate the user 402 (e.g., one or more of a sound-based sensor, a motion-based sensor, and an image-based sensor). At block 506, the processor 202 receives a first set of data regarding the user 402 from a sensor of the identified first type (e.g., one or more of motion data, sound data, and image data). At block 508, the processor 202 carries out a first authentication procedure on the user 402 using the received first set of data. At block 510, the processor 202 grants a first level access to the user 402 based on the first authentication procedure.

At block 512, the device 100 (i.e., one or more of its sensors) detects one or both of the second position and the second motion of the user 402. At block 514, the processor 202 identifies, based on one or both of the second detected position and the second detected motion, which type of sensor is most appropriate to use to authenticate the user 402 (e.g., one or more of a sound-based sensor, a motion-based sensor, and an image-based sensor). At block 516, the processor 202 receives a second set of data regarding the user 402 from a sensor of the identified second type (e.g., one or more of motion data, sound data, and image data). At block 518, the processor 202 carries out a second authentication procedure on the user 402 using the received second set of data. At block 520, the processor 202 grants a second level access to the user 402 based on the second authentication procedure.

It should be understood that the embodiments described herein should be considered in a descriptive sense only and not for purposes of limitation. Descriptions of features or aspects within each embodiment should typically be considered as available for other similar features or aspects in other embodiments.

While one or more embodiments of the have been described with reference to the figures, it will be understood by those of ordinary skill in the art that various changes in form and details may be made therein without departing from their spirit and scope of as defined by the following claims. For example, the steps of the process flow diagrams of FIG. 3 and FIG. 5 can be reordered in way that will be apparent to those of skill in the art. Steps may also be added to the flow diagrams of FIGS. 3 and 5 without departing from the spirit of the disclosure.

We claim:

1. A method for controlling access to an electronic device, the method comprising:
detecting a first position of a user relative to the electronic device;
based on the first detected position, selecting a first sensor of the electronic device to be used for authenticating the user;
granting a first level access to the user based on a first authentication procedure carried out with the first sensor;
detecting a second position and motion of the user relative to the electronic device;
based on the second detected position and motion, selecting a second sensor of the electronic device to be used for authenticating the user; and
granting a second level access to the user based on an authentication procedure carried out with the second sensor.

2. The method of claim 1, wherein
selecting a first sensor comprises selecting a sound sensor;
granting a first level of access to the user comprises granting a first level of access to the user based on sound recognition performed on sound from the user as detected by the sound sensor;
selecting a second sensor comprises selecting an imager;
granting a second level of access to the user comprises granting a second level of access to the user based on facial recognition performed on the user's face as captured by the imager.

3. The method of claim 2, wherein the sound is the user's voice or the user's gait.

4. The method of claim 1, wherein
selecting a first sensor comprises selecting an imager,
granting a first level of access to the user comprises granting a first level of access to the user based on facial recognition performed on the user's face as captured by the imager,
selecting a second sensor comprises selecting an eye scanner
granting a second level of access to the user comprises granting a second level of access to the user based on an eye scan performed on the user's eye by the eye scanner.

5. The method of claim 4, further comprising activating the eye scanner based on the detected second position and motion of the user, wherein the eye scan is selected from a group consisting of a retina scan, an iris scan, and a vein scan.

6. The method of claim 1, wherein
selecting a first sensor comprises selecting an imager,
granting a first level of access to the user comprises granting a first level of access to the user based on facial recognition performed on the user's face as captured by the imager,
selecting a second sensor comprises selecting a fingerprint reader,
granting a second level of access to the user comprises granting a second level of access to the user based on a fingerprint scan performed on the user's finger by the fingerprint reader.

7. The method of claim 1, wherein
granting the first level of access comprises granting the user access to telephone functions of the electronic device,
granting the second level of access comprises granting the user access to one or more of pictures, files, and emails on the electronic device.

8. The method of claim 1, further comprising detecting a speed of the user; and
selecting the second sensor of the electronic device to be used for authenticating the user based at least in part on the detected speed.

9. The method of claim 1, further comprising detecting a context of the electronic device; and
selecting the second sensor of the electronic device to be used for authenticating the user based at least in part on the detected context.

10. An electronic device comprising:
a plurality of sensors, including a motion sensor configured to
detect a first position of the user relative to the electronic device;
detect a second position and motion of the user relative to the electronic device;
a processor configured to
based on the first detected position and motion, select a first sensor of the plurality of sensors to be used for authenticating the user;
grant a first level access to the electronic device to the user based on a first authentication procedure carried out with the first sensor;
based on the second detected position and motion, selecting a second sensor of the plurality of sensors to be used for authenticating the user; and
granting a second level of access to the electronic device to the user based on an authentication procedure carried out with the second sensor.

11. The electronic device of claim 10, wherein
the first sensor is a sound sensor;
the second sensor is an imager;
the processor is configured to grant the first level of access based on sound recognition performed on sound from the user as detected by the sound sensor;
the processor is configured to grant the second level of access to the user based on facial recognition performed on the user's face as captured by the imager.

12. The electronic device of claim 11, wherein the sound is the user's voice or the user's gait.

13. The electronic device of claim 10, wherein
the first sensor is an imager;
the second sensor is an eye scanner;
the processor is configured to grant the first level of access based on facial recognition performed on the user using image data collected by the imager;
the processor is configured to grant the second level of access to the user based on an eye scan performed on the user's eye by the eye scanner.

14. The electronic device of claim 13, wherein the eye scan is selected from a group consisting of a retina scan, an iris scan, and a vein scan.

15. The electronic device of claim 10, wherein
the first sensor is an imager,
the second sensor is a fingerprint reader,
the processor is configured to grant a first level of access to the user based on facial recognition performed on the user's face as captured by the imager,
the processor is configured to grant a second level of access to the user based on a fingerprint scan performed on the user's finger by the fingerprint reader.

16. The electronic device of claim 10, wherein
the first level of access comprises access to telephone functions of the electronic device,
the second level of access comprises access to one or more of pictures, files, and emails on the electronic device.

17. A method for controlling access to an electronic device comprising a plurality of types of sensors, the method comprising:
detecting one or both of a first position and a first motion of a user relative to the electronic device;
based on one or both of the first detected position and the first detected motion, identifying which type of sensor of the plurality of types of sensors is the most appropriate for use in attempting to authenticate the user;
receiving a first set of data regarding the user from a sensor of the identified first type;
carrying out a first authentication procedure on the user using the received first set of data;
granting a first level access to the user based on the first authentication procedure;
detecting one or both of a second position and a second motion of the user relative to the electronic device;
based on one or both of the second detected position and second detected motion, identifying which type of sensor of the plurality of types of sensors is the most appropriate for use in attempting to authenticate the user;
receiving a second set of data regarding the user from a sensor of the identified second type;
carrying out a second authentication procedure on the user using the received second set of data; and
granting a second level of access to the user based on the second authentication procedure, wherein the second level of access is higher than the first level of access.
